(19) United States
(12) Patent Application Publication
(10) Pub. No.: US 2012/0125974 A1
(43) Pub. Date: May 24, 2012

(54) COMPLETE FLOOR WELDING SYSTEM FOR VARIOUS VEHICLE MODELS

(75) Inventor: Tae Yong Kwon, Suwon (KR)

(73) Assignee: HYUNDAI MOTOR COMPANY, Seoul (KR)

(21) Appl. No.: 13/164,021

(22) Filed: Jun. 20, 2011

(30) Foreign Application Priority Data
Nov. 23, 2010 (KR) 10-2010-0116621

(51) Int. Cl. B23K 37/00

(52) U.S. Cl. 228/8

(57) ABSTRACT

The present disclosure relates to a welding system applied to a chassis assembly line for vehicles, and more particularly to a complete floor welding system for various vehicle models. The complete floor welding system for various vehicle models adapted to perform a welding operation after determining and regulating positions of welding spots different according to models of vehicles, comprises: at least one external unit for welding a plurality of parts disposed in a key welding process of a complete floor welding line and having an automatic spot welding gun, the external unit being configured to determine a position according to a model of a vehicle and enter a complete floor from three sides of the complete floor to perform a welding operation; a post structure for installing the external unit; and a controller configured to control the external unit.

### CROSS-REFERENCE TO RELATED APPLICATION

This application claims under 35 U.S.C. §119(a) the benefit of Korean Patent Application No. 10-2010-0116621 filed Nov. 23, 2010, the entire contents of which are incorporated herein by reference.

### BACKGROUND

(a) Technical Field

The present disclosure relates to a complete floor welding system applicable to a chassis assembly line for manufacture of vehicles.

(b) Background Art

In general, a vehicle manufacturing process involves assembly of numerous parts of a vehicle. Especially, in a chassis assembling process, chassis panels produced via pressing are assembled into chassis as a white body, and floors, doors, trunk lids, hoods, and fenders are then mounted therein.

Recently, a transferring carriage system has been employed to chassis assembling process for various vehicles to promptly meet the request due to changes in vehicle types. Such a vehicle transferring carriage system transfers chassis panels and parts to a work process corresponding to various types of vehicles to automate the process.

In a typical carriage system, a jig and parts are moved in between two processes while the parts are clamped to a chassis in a chassis factory. The term “complete floor” herein means a state in which the assembly of front, center, and rear floor parts forming a bottom side of a chassis is completed.

In addition to the assembly process using a transferring carriage system, a typical vehicle manufacturing process involves a welding process. FIG. 1 illustrates a conventional complete floor welding line which includes a spot welding process 10 and a key welding process 11 and largely depends on robots. The conventional complete floor welding system has problems. First, it is not easy to redesign an existing welding related program in connection with the behaviors of robots in case where a considerable adjustment of the size and shape of vehicle panels is required for a new vehicle model. Second, the key welding process requires automatic welding guns by using four robots, for which investment costs may be increased and maintaining and repairing the system may become difficult.

### SUMMARY OF THE DISCLOSURE

The present invention provides a complete floor welding system for various vehicle models that requires a novel type of complete floor key welding system obtained by combining several external units for welding of parts, wherein each unit includes a three-axis sliding unit configured to determine welding spots according to the model of a vehicle, a part-fixing pin clamp, and an automatic unilateral spot welding gun configured to weld parts, actively complying with various vehicle models and improving the efficiency of the entire welding process.

In one aspect, the present invention provides a complete floor welding system for various vehicle models adapted to perform a welding operation after determining and regulating positions of welding spots according to models of vehicles, comprising: at least one external unit for welding a plurality of parts disposed in a key welding process of a complete floor welding line and having an automatic spot welding gun, the external unit being configured to determine a position according to a model of a vehicle and enter a complete floor from three sides of the complete floor to perform a welding operation; a post structure for installing the external unit; and a controller configured to control the external unit.

Preferably, the external unit includes: a three-axis sliding unit having an X-axis linear motion, a Y-axis linear motion, and a Z-axis linear motion and configured to determine a position according to a model of a vehicle; a part-fixing pin clamp installed at an end of the Y-axis linear motion of the three-axis sliding unit and configured to regulation of a position of a part; an automatic gun linear motion installed on the Y-axis linear motion of the three-axis sliding unit; a servo motor installed on one side of the automatic gun linear motion to cross the automatic gun linear motion; and an automatic unilateral spot welding gun installed in the automatic gun linear motion to be moved together with the automatic gun linear motion and configured to perform a welding operation while moving in the X-axis direction.

The complete floor welding system for various vehicle models according to the present invention has the following advantages.

First, seal side welding/back panel welding external units are installed in a complete floor key welding process of a complete floor welding line to perform a welding operation such that it unilaterally searches and enters a welding spot according to vehicle models, enabling it to easily comply with the change in vehicle models.

Second, since a total of six part-welding external units perform welding operation according to the sequential order of welding spots, a welding operation can be effectively performed. In particular, investment cost for equipment can be greatly reduced as compared with that for automatic welding by an existing robot while the management efficiency related to maintenance and repair can be increased.

Third, six part-welding external units are respectively disposed on three sides of the complete floor, and thus a degree of freedom related to a design of factory layouts can be improved. For example, the space occupancy in layouts can be lowered.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a top view illustrating a conventional complete floor welding line;

FIG. 2 is a perspective view illustrating a part-welding external unit of a complete floor welding system for various vehicle models according to an embodiment of the present invention;

FIGS. 3A to 3C are perspective views illustrating X-axis, Y-axis, and Z-axis operation states of the part-welding external unit of FIG. 2, respectively;

FIG. 4 is a top view illustrating welding wires of the part-welding external unit of the complete floor welding system for various vehicle models according to the embodiment of the present invention;

FIG. 5 is a top view illustrating a state in which the part-welding external unit of the complete floor welding system for various vehicle models according to the embodiment of the present invention is installed in a welding line; and

FIG. 6 illustrates a schematic view of operations and welding states of the part-welding external unit of the complete floor welding system for various vehicle models according to the embodiment of the present invention.

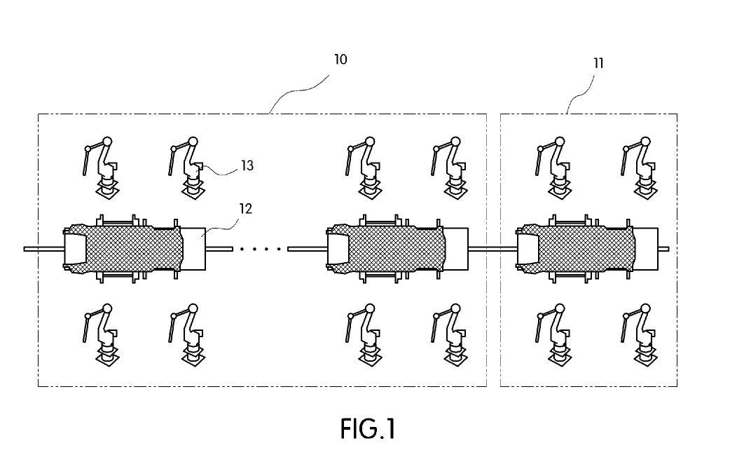

### DETAILED DESCRIPTION

Hereinafter, exemplary embodiments of the present invention will be described below in detail with reference to the accompanying drawings such that those skilled in the art to which the present invention pertains can easily practice the present invention.

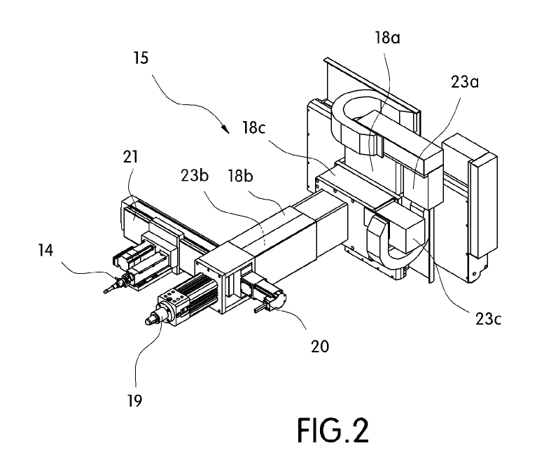

FIG. 2 is a perspective view illustrating a part-welding external unit of a complete floor welding system for various vehicle models according to an embodiment of the present invention.

As illustrated in FIG. 2, the complete floor welding system includes a part-welding external unit 15 for performing a welding operation, a post structure (not shown) for supporting the part-welding external unit 15, and a controller (not shown) for controlling the part-welding external unit 15. The complete floor welding system is adapted to perform a welding operation after determining welding spots, which are different according to vehicle models, and regulating positions of parts.

In particular, the part-welding external unit 15 is disposed in a key welding process 11 of a complete floor welding line. Unlike the conventional welding system using robots, the part-welding external unit 15 is disposed at three sides of the complete floor and is adapted to weld the welding spots of the parts entering the key welding process 11 unilaterally.

Such part-welding external units 15, i.e., seal side and back panel welding external units can be used to various vehicle models. Each of the units includes a three-axis sliding unit 18 configured to determine the position of a complete floor according to vehicle models, a part-fixing pin clamp 19, and an automatic unilateral spot welding gun 14 configured to weld a seal side part to a floor part, and a back panel part to a floor part.

A detailed configuration of the part-welding external unit 15 is as follows. The three-axis sliding unit 18 regulates the position of a part (i.e., a complete floor) prior to starting a welding operation. When a complete floor mounted on a complete floor carriage 12 is transferred to the key welding process 11 along a welding line, the three-axis sliding unit 18 is operated in the X-axis, Y-axis, and Z-axis directions to fix the position of the complete floor. To achieve this, the three-axis sliding unit 18 includes an X-axis linear motion 18a and a motor 23a, a Y-axis linear motion 18b and a motor 23b, and a Z-axis linear motion 18c and a motor 23c that may be moved in the respective directions to determine the position of the complete floor according to vehicle models.

That is, an X-axis motion guide 25a is installed in parallel to the X-axis direction on a front surface of the post structure 16 adapted to support the three-axis sliding unit 18. The X-axis linear motion 18a and the motor 23a are coupled to the X-axis motion guide 25a so that they can be moved in the X-axis direction along the X-axis motion guide 25a.

A Z-axis motion guide 25c is installed in parallel to the Z-axis direction on the X-axis linear motion 18a. The Z-axis linear motion 18c and the motor 23c are coupled to the Z-axis motion guide 25c so that they can be moved in the Z-axis direction along the Z-axis motion guide 25c.

A Y-axis motion guide 25b is installed parallel to the Y-axis direction on the Z-axis linear motion 18c. The Y-axis linear motion 18b and the motor 23b are coupled to the Y-axis motion guide 25b so that they can be moved in the Y-axis direction along the Y-axis motion guide 25b.

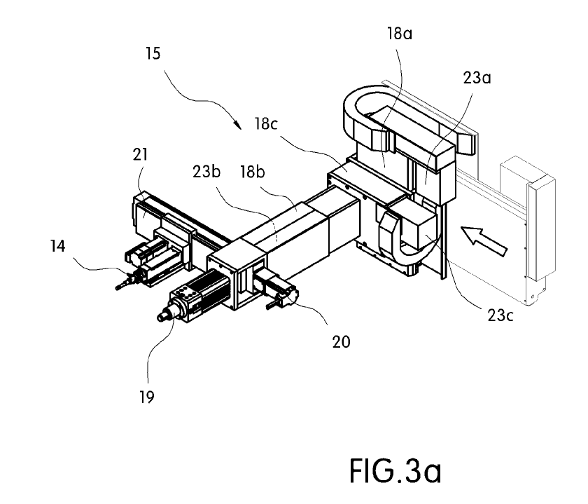

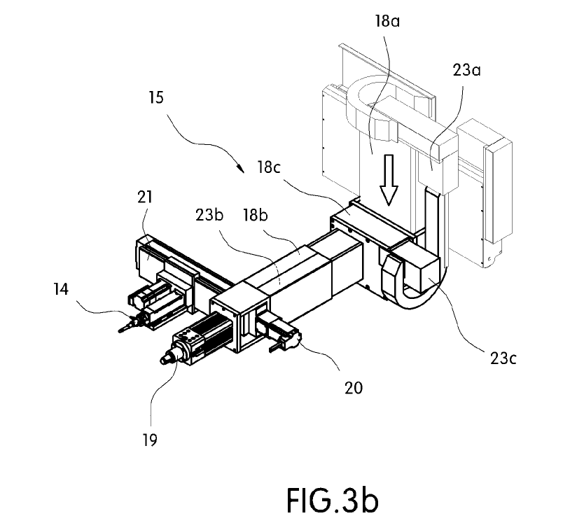

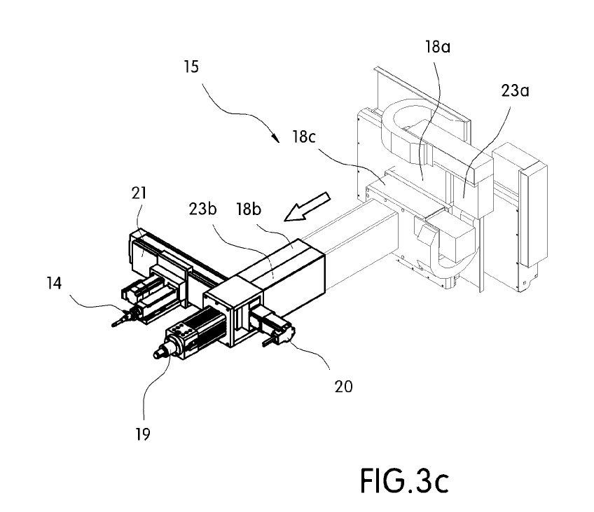

Thus, the three-axis sliding unit 18 is operated as illustrated in FIGS. 3A to 3C through the movement of the linear motions to regulate the position of the complete floor using the part-fixing pin clamp 19.

For example, as illustrated in FIG. 3A, if the motor 23a is operated, the X-axis linear motion 18a is moved in the X-axis direction along the X-axis motion guide 25a.

As a result, all of the X-axis linear motion 18a and the motor 23a, the Z-axis linear motion 18c and the motor 23c, the Y-axis linear motion 18b and the motor 23b, the automatic unilateral spot welding gun 14, and the part-fixing pin clamp 19 are moved in the X-axis direction by the operation of the motor 23a.

As illustrated in FIG. 3B, if the motor 23c is operated, the Z-axis linear motion 18c is moved in the Z-axis direction along the Z-axis motion guide 25c.

As a result, all of the Z-axis linear motion 18c and the motor 23c, the Y-axis linear motion 18b and the motor 23b, the automatic unilateral spot welding gun 14, and the part-fixing pin clamp 19 are moved in the Z-axis direction.

As illustrated in FIG. 3C, if the motor 23b is operated, the Y-axis linear motion 18b is moved in the Y-axis direction along the Y-axis motion guide 25b.

As a result, all of the Y-axis linear motion 18b and the motor 23b, the automatic unilateral spot welding gun 14, and the part-fixing pin clamp 19 are moved in the Y-axis direction by the operation of the motor 23b.

The part-fixing pin clamp 19 is directly inserted into a position regulating hole (not shown) of the complete floor to fix the complete floor and is installed at an end of the Y-axis linear motion 18b of the three-axis sliding unit 18 such that the part-fixing pin clamp 19 searches a fixing point to fix the complete floor by the operation of the three-axis sliding unit 18.

The automatic unilateral spot welding gun 14 performs a welding operation on welding spots of the complete floor while moving in the X-axis direction. To achieve this, an automatic gun linear motion 21 extending along the X-axis direction is provided on the Y-axis linear motion 18b to cross the Y-axis linear motion 18b and a serve motor 20 is installed on one side of the automatic gun linear motion 21 to operate the automatic gun linear motion 21. The automatic unilateral spot welding gun 14 is installed on the automatic gun linear motion 21 to move together such that it performs a welding operation on welding spots while moving in the X-axis direction.

A support block 26 is installed at an end of the Y-axis linear motion 18b. The motion guide 21a of the automatic gun linear motion 21 is installed long in the support block 26 along the X-axis direction and the automatic unilateral spot welding gun 14 is installed in the motion block 21b moving along the motion guide 21a.

Accordingly, if the servo motor 20 is operated, the automatic unilateral spot welding gun 14 is moved together with the motion block 21b along the X-axis direction to fix its location.

Thus, if the location of the part-fixing pin clamp 19 is fixed by the operations of the three-axis sliding units 18a, 18b, and 18c and the drive motors 23a, 23b, and 23c, allowing the floor complete to be fixed, the linear motion guide 21 is moved in the X-axis direction by the operation of the servo motor 20. Then, the automatic unilateral spot welding gun 14 is moved along the X-axis direction, performing welding operations on welded points.

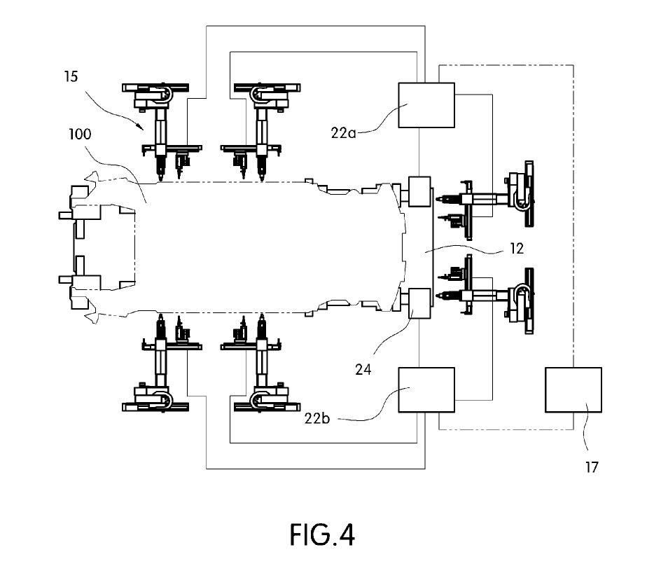

FIG. 4 is a top view illustrating welding wires of the part-welding external unit of the complete floor welding system for various vehicle models according to the embodiment of the present invention.

FIG. 4 illustrates an arrangement and a welding diagram of six part-welding external units 15 configured to perform welding operations on the complete floor 100.

Three pairs of the part-welding external units 15 are disposed on the periphery, i.e. three sides of the floor complete 100 located in a key welding process 11 and two unilateral welding machines 22a and 22b control the welding operations of the part-welding external units 15. Here, each pair of the part-welding external units 15 may be installed on a single frame structure 16.

Three part-welding external units 15 are connected to the two unilateral welding machines 22a and 22b controlled by the controller 17 respectively, and the three external units 15 perform welding operations with predetermined time intervals between the operations thereof.

A ground 24 is connected to a base of the floor carriage 12 in the form of a clamp in the automatic unilateral welding machines 22a and 22b.

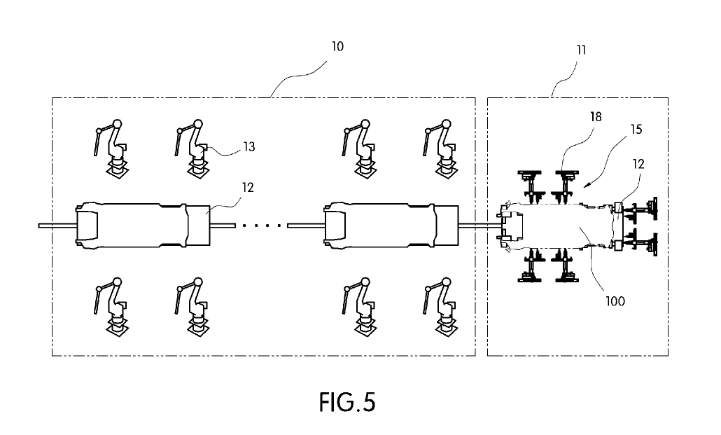

FIG. 5 is a top view illustrating a state in which the part-welding external unit of the complete floor welding system for various vehicle models according to the embodiment of the present invention is installed in a welding line.

As illustrated in FIG. 5, the complete floor welding system includes a spot welding process 10 and a key welding process 11 and the floor complete carriage 12 is moved along the entire complete floor welding line.

Automatic welding guns 13 perform welding operations using robots in the spot welding process 10 and the three part-welding external units 15 perform welding operations in the key welding process 11.

Accordingly, when a key welding process 11 is performed on a different vehicle model, the part-welding external unit 15 may suitably regulate the position of the complete floor of the vehicle model through the three-axis operation and the automatic unilateral spot welding guns may perform welding operations on welding spots of the vehicle model while moving in the X-axis direction.

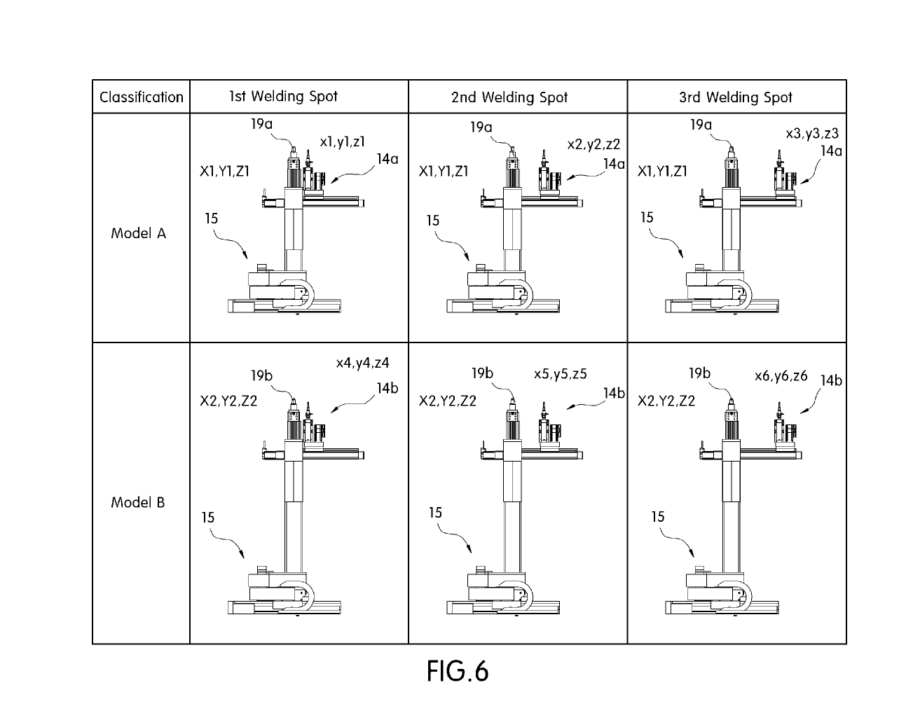

FIG. 6 illustrates a schematic view of operations and welding states of the part-welding external unit of the complete floor welding system for various vehicle models according to the embodiment of the present invention.

The positions of the part-fixing pin clamps 19a and 19b are fixed to X1, Y1, and Z1 for a vehicle model A and to X2, Y2, and Z2 for a vehicle model B by the three-axis operations of the part-welding external units 15a and 15b.

With the part-fixing pin clamps 19a and 19b being fixed to the complete floor, the automatic unilateral spot welding guns 14a and 14b are moved in the X-axis direction according to the sequence of the welding spots such that welding operations are performed at x1, y1, and z1 for the vehicle model A and at x2, y2, and z2 for the vehicle model B.

As described above, the complete floor welding system for various vehicle models according to the present invention includes several sets of part-welding external units each of which includes a three-axis sliding unit configured to determine welding spots according to vehicle models, a part-fixing pin clamp, and an automatic unilateral spot welding gun configured to weld parts such that a key welding process can be performed in a complete floor welding line, thereby making the system compatible with various vehicle models and efficiently perform the entire welding process.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents. Further, many modifications may be made to specific situations and materials without departing from the essence of the invention. Therefore, the present invention is not limited to the detailed description of the preferred embodiments but include all embodiments within the scope of the attached claims.

What is claimed is:

1. A complete floor welding system for various vehicle models configured to perform a welding operation after determining and regulating positions of welding spots different according to models of vehicles, comprising:
at least one external unit for welding a plurality of parts disposed in a key welding process of a complete floor welding line, the at least one external unit having an automatic unilateral spot welding gun, wherein the external unit is configured to determine a position to perform the welding operation according to a model of a vehicle and install a complete floor from three sides of the complete floor in order to perform a welding operation;
a post structure for installing the external unit; and
a controller configured to control the at least one external unit.

2. The complete floor welding system of claim 1, wherein the external unit includes:
a three-axis sliding unit having an X-axis linear motion, a Y-axis linear motion, and a Z-axis linear motion and configured to determine a position according to a model of a vehicle;
a part-fixing pin clamp installed at an end of the Y-axis linear motion of the three-axis sliding unit and configured to regulate a position of a part;
an automatic gun linear motion installed on the Y-axis linear motion of the three-axis sliding unit;
a servo motor installed on one side of the automatic gun linear motion to cross the automatic gun linear motion; and
an automatic unilateral spot welding gun installed in the automatic gun linear motion to be moved together with the automatic gun linear motion and configured to perform a welding operation while moving in the X-axis direction.

3. The complete floor welding system of claim 1, wherein three external units are respectively connected to two unilateral welding machines controlled by the controller to perform welding operations within time gaps.

4. The complete floor welding system of claim 1, wherein six external units are provided such that two of the external unit form a pair, wherein three pairs of external units are installed in the post structure and are respectively disposed on three sides of the complete floor.

5. A complete floor welding system for welding a complete floor in various vehicle models, comprising:
a plurality of external units for welding of parts on the various vehicle models, wherein each external unit includes:
a three-axis sliding unit configured to determine, by a controller, one or more welding spots on the complete floor according to the model of a vehicle,
a part-fixing pin clamp to regulate a position of the complete floor, and
an automatic unilateral spot welding gun configured to weld a seal side part to a floor part of the complete floor, and a back panel part to the floor part.

6. The complete floor welding system of claim 5, the system further comprising:
a post structure for installing the external unit.

7. The complete floor welding system of claim 5, wherein the three-axis sliding unit further comprises an X-axis linear motion, a Y-axis linear motion, and a Z-axis linear motion, the part-fixing pin clamp is installed at an end of the Y-axis linear motion of the three-axis sliding unit and configured to regulate a position of a part; and the automatic gun linear motion is installed on the Y-axis linear motion of the three-axis sliding unit

8. The complete floor welding system of claim 7, wherein each of the external units further comprises
a servo motor installed on one side of the automatic gun linear motion to cross the automatic gun linear motion; and
the automatic unilateral spot welding gun is installed in the automatic gun linear motion to be moved together with the automatic gun linear motion and configured to perform a welding operation while moving in the X-axis direction.

9. The complete floor welding system of claim 5, wherein three external units are respectively connected to two unilateral welding machines controlled by the controller to perform welding operations within time gaps.

10. The complete floor welding system of claim 5, wherein six external units are provided such that two of the external unit form a pair, wherein three pairs of external units are installed in the post structure and are respectively disposed on three sides of the complete floor.
